(19) United States
(12) Patent Application Publication
(10) Pub. No.: US 2006/0184949 A1
(43) Pub. Date: Aug. 17, 2006

(54) Methods, systems, and storage mediums for timing work requests and completion processing

(75) Inventors: David F. Craddock, New Paltz, NY (US); William J. Rooney, Hopewell Junction, NY (US); Donald W. Schmidt, Stone Ridge, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/057,943

(22) Filed: Feb. 15, 2005

(51) Int. Cl. G06F 9/46

(52) U.S. Cl. 719/314

(57) ABSTRACT

I/O adapters, such as InfiniBand™ host channel adapters (HCAs) or iWarp remote network interface cards (RNICs) use work requests to pass information to a queue pair and work completions to determine when a work request has completed. Timing information in various stages of processing of these work requests allow a workload manager to identify sources of delay that impacts transaction processing. Work requests request processing that can be marked with a timestamp. Processing stages include: (1) the time when the work request is posted to the send queue, (2) the time when the first packet is sent on the link for that work request, (3) the time at which the work request has completed its processing, and (4) the time when the work completion is retrieved by the software. By comparing the timestamps, the workload manager determines the processing and transaction times.

### BACKGROUND OF THE INVENTION

1. Field of the Invention

The present invention relates generally to computer and processor architecture and processor input/output (I/O) interfacing and, in particular, to timing work requests and completion processing in I/O.

2. Description of Related Art

The management of workload plays an important role in computing environments. Various aspects of processing within a computing environment are scrutinized to ensure a proper allocation of resources and to determine whether any constraints exist. One type of processing that is scrutinized is I/O processing.

In I/O processing, workload management includes allocating available I/O resources to various workloads. The allocation of resources includes the case where sufficient resources exist; however allocation is necessary to assure that all workloads can achieve their goals. The allocation of resources also includes the case where resources are constrained and available resources must be shifted to work that has high business value at the expense of less important work.

Because there are several resources that are used in order to process an I/O request, it is important to determine which of those resources is constrained in order to alleviate the problem. For example, an I/O request could be delayed by queuing in the I/O fabric, queuing of the request in the device (or control unit), cache miss, distance between endpoints and other mechanisms. Some of these delays are addressable by adjusting the appropriate resource allocation; however I/O response time alone is inadequate to determine which of the resources is causing the delay.

A need exists for timing work requests and completion processing in I/O. I/O adapters, such as InfiniBand™ host channel adapters (HCAs) and iWarp remote network interface cards (RNICs) use work requests to pass information to a queue pair and use work completions to determine when a particular work request has completed.

### BRIEF SUMMARY OF THE INVENTION

The present invention is directed to methods, systems, and storage mediums for timing work requests and completion processing.

One aspect is a method for timing work requests and completion processing. A software driver stores a time t1 when a work request is posted to a send queue. A hardware adapter posts a work completion corresponding to the work request to a completion queue. The work completion includes a time t2 when the message for the work request is sent on the link and a time t3 when the work completion is posted to the completion queue. The software driver retrieves the work completion corresponding to the work request and stores a time t4 when the work completion is retrieved from the completion queue. Another aspect is a storage medium storing instructions for performing this method.

Another aspect is a system for timing work requests and completion processing, including a hardware adapter, a software driver, a send queue, and a completion queue. The hardware adapter sends packets on a link. The software driver controls the hardware adapter. The send queue holds work requests. The completion queue holds work completions. The software driver provides a time t1 when a work request is posted to the send queue. The hardware adapter provides a time t2 when a message for the work request is sent on the link. The hardware adapter provides a time t3 when a work completion corresponding to the work request is posted to the completion queue. The software driver provides a time t4 when the work completion is retrieved from the completion queue.

### BRIEF DESCRIPTION OF THE DRAWINGS

These and other features, aspects, and advantages of the present invention will become better understood with regard to the following description, appended claims, and accompanying drawings, where:

FIG. 1 is a diagram of a distributed computer system in the prior art that is an exemplary operating environment for embodiments of the present invention;

FIG. 2 is a diagram of a host channel adapter in the prior art that is part of an exemplary operating environment for embodiments of the present invention;

FIG. 3 is a diagram illustrating processing of work requests in the prior art that is part of an exemplary operating environment for embodiments of the present invention;

FIG. 4 is a diagram illustrating a portion of a distributed computer system in the prior art in which a reliable connection service is used that is part of an exemplary operating environment for embodiments of the present invention;

FIG. 5 is a diagram of a layered communication architecture used in the prior art that is part of an exemplary operating environment for embodiments of the present invention; and

FIG. 6 is a block diagram showing timestamp recording and reporting for work requests and work completions according to an exemplary embodiment.

### DETAILED DESCRIPTION OF THE INVENTION

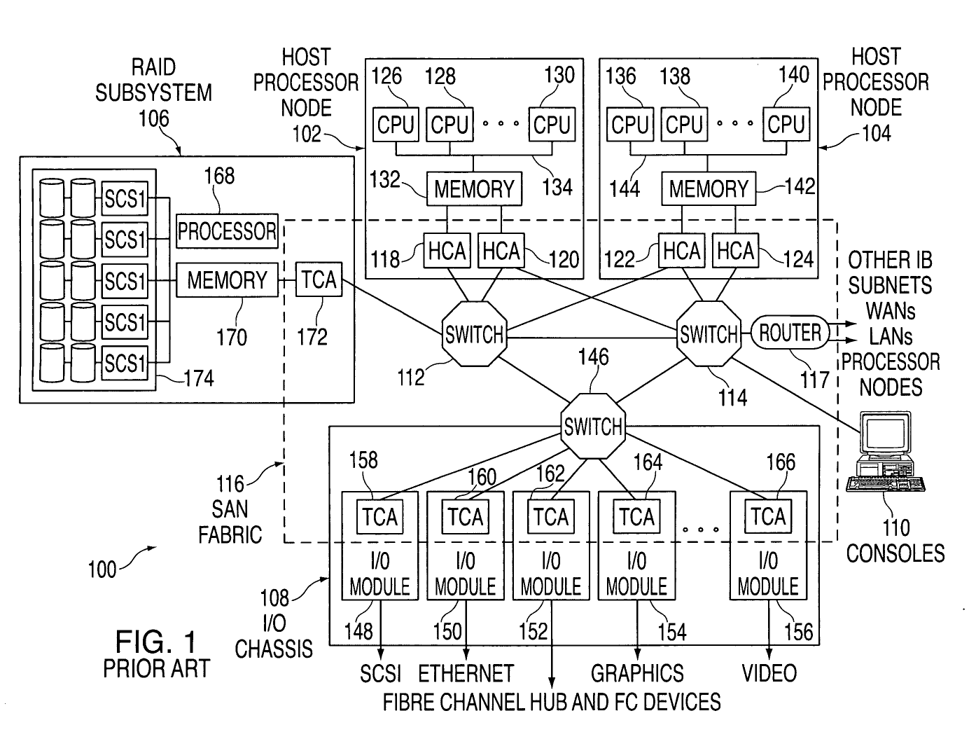

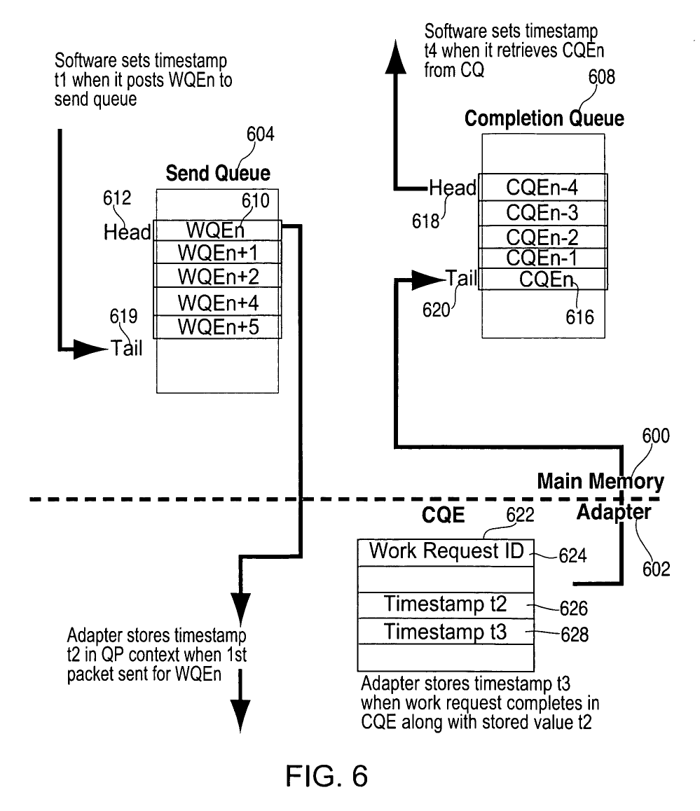

Exemplary embodiments are directed to methods, systems, and storage mediums for timing work requests and completion processing. Exemplary embodiments are preferably implemented in a distributed computing system, such as a prior art system area network (SAN) having end nodes, switches, routers, and links interconnecting these components. FIGS. 1-5 show various parts of an exemplary operating environment for embodiments of the present invention. FIG. 6 shows timestamp recording and reporting for work requests and work completions according to an exemplary embodiment.

FIG. 1 is a diagram of a distributed computer system. The distributed computer system represented in FIG. 1 takes the form of a system area network (SAN) 100 and is provided merely for illustrative purposes. The exemplary embodiments of the present invention described below can be implemented on computer systems of numerous other types and configurations. For example, computer systems implementing the exemplary embodiments can range from a small server with one processor and a few input/output (I/O) adapters to massively parallel supercomputer systems with hundreds or thousands of processors and thousands of I/O adapters.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an end node, which is herein defined to be a device that originates or finally consumes messages or frames in SAN 100.

A message, as used herein, is an application-defined unit of data exchange, which is a primitive unit of communication between cooperating processes. A packet is one unit of data encapsulated by networking protocol headers and/or trailers. The headers generally provide control and routing information for directing the frame through SAN 100. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low-latency in a secure, remotely managed environment. End nodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Global Routing Header (GRH).

In one embodiment, a link is a full duplex channel between any two network fabric elements, such as end nodes, switches, or routers. Example suitable links include, but are not limited to, copper cables, optical cables, and printed circuit copper traces on backplanes and printed circuit boards.

For reliable service types, end nodes, such as host processor end nodes and I/O adapter end nodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 116. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communication (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers. The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148, an adapter card to fiber channel hub and fiber channel arbitrated loop (FC-AL) devices for I/O module 152; an Ethernet adapter card for I/O module 150; a graphics adapter card for I/O module 154; and a video adapter card for I/O module 156. Any known type of adapter card can be implemented. I/O adapters also include a switch in the I/O adapter to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among them or communicate with any or all of the processor nodes in distributed computer systems. With an I/O adapter attached to the SAN 100 the resulting I/O adapter node has substantially the same communication capability as any host processor node in SAN 100.

In one embodiment, the SAN 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the packet transmitted from a source process specifies a destination processes' communication port, but does not specify where in the destination processes' memory space the packet will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data packet containing the destination buffer memory address of the destination process. In memory semantics, the destination process previously grants permission for the source process to access its memory.

Channel semantics and memory semantics are typically both necessary for I/O and interprocessor communications. A typical I/O operation employs a combination of channel and memory semantics. In an illustrative example I/O operation of the distributed computer system shown in FIG. 1, a host processor node, such as host processor node 102, initiates an I/O operation by using channel semantics to send a disk write command to a disk I/O adapter, such as RAID subsystem target channel adapter (TCA) 172. The disk I/O adapter examines the command and uses memory semantics to read the data buffer directly from the memory space of the host processor node. After the data buffer is read, the disk I/O adapter employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computer system are not required to use physical addressing for any operations.

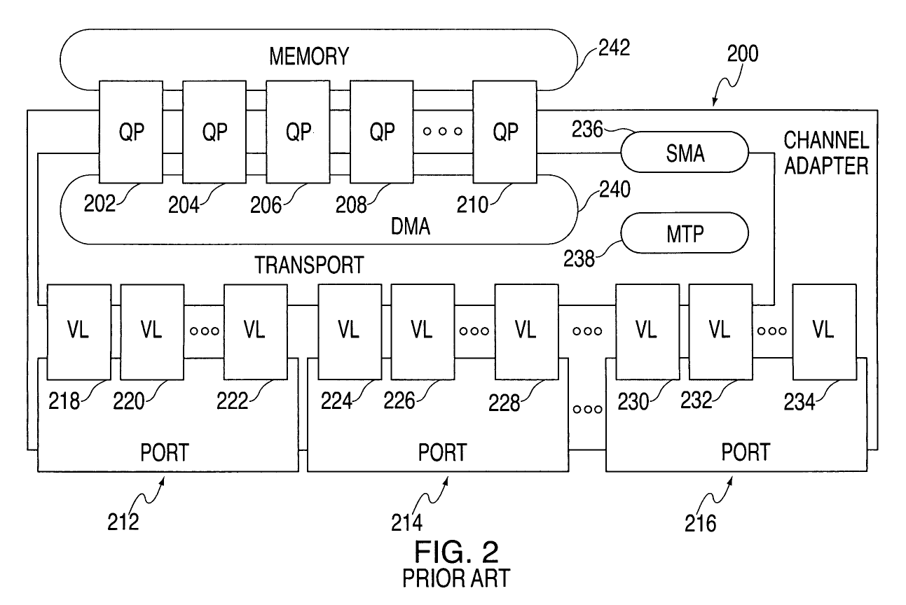

With reference now to FIG. 2, a diagram of a host channel adapter in the prior art is depicted. Host channel adapter 200 shown in FIG. 2 includes a set of queue pairs (QPs) 202-210, which are used to transfer messages to the host channel adapter ports 212-216. Buffering of data to host channel adapter ports 212-216 is channeled through virtual lanes (VL) 218-234 where each VL has its own flow control. Subnet manager configures the channel adapter with the local addresses for each physical port, i.e., the port's LID. Subnet manager agent (SMA) 236 is the entity that communicates with the subnet manager for the purpose of configuring the channel adapter. Memory translation and protection (MTP) 238 is a mechanism that translates virtual addresses to physical addresses and validates access rights. Direct memory access (DMA) 240 provides for direct memory access operations using memory 242 with respect to queue pairs 202-210.

A single channel adapter, such as the host channel adapter 200 shown in FIG. 2, can support thousands of queue pairs. By contrast, a target channel adapter in an I/O adapter typically supports a much smaller number of queue pairs. Each queue pair consists of a send work queue (SWQ) and a receive work queue. The send work queue is used to send channel and memory semantic messages. The receive work queue receives channel semantic messages. A consumer calls an operating system specific programming interface, which is herein referred to as verbs, to place work requests (WRs) onto a work queue.

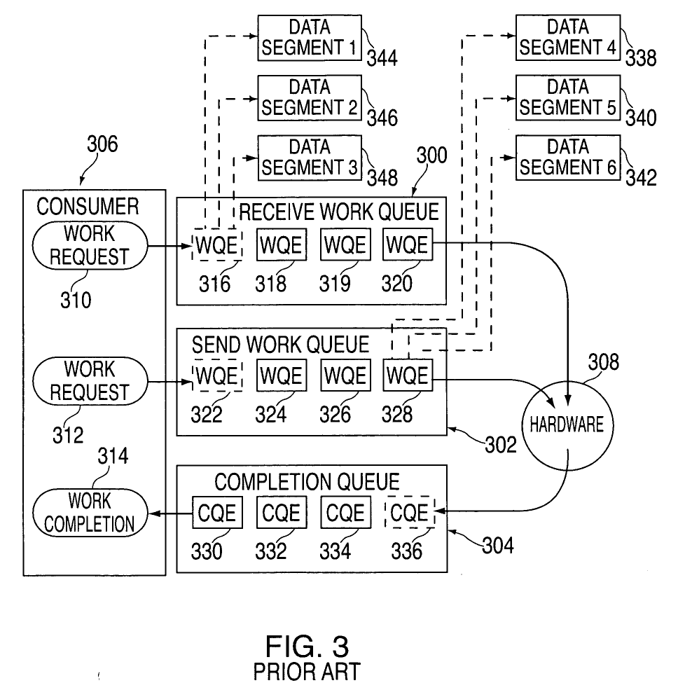

With reference now to FIG. 3, a diagram illustrating processing of work requests in the prior art is depicted. In FIG. 3, a receive work queue 300, send work queue 302, and completion queue 304 are present for processing requests from and for consumer 306. These requests from consumer 306 are eventually sent to hardware 308. In this example, consumer 306 generates work requests 310 and 312 and receives work completion 314. As shown in FIG. 3, work requests placed onto a work queue are referred to as work queue elements (WQEs).

Send work queue 302 contains work queue elements (WQEs) 322-328, describing data to be transmitted on the SAN fabric. Receive work queue 300 contains work queue elements (WQEs) 316-320, describing where to place incoming channel semantic data from the SAN fabric. A work queue element is processed by hardware 308 in the host channel adapter.

The verbs also provide a mechanism for retrieving completed work from completion queue 304. As shown in FIG. 3, completion queue 304 contains completion queue elements (CQEs) 330-336. Completion queue elements contain information about previously completed work queue elements. Completion queue 304 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 302 shown in FIG. 3 are as follows. A send work request is a channel semantic operation to push a set of local data segments to the data segments referenced by a remote node's receive work queue element. For example, work queue element 328 contains references to data segment 4 338, data segment 5 340, and data segment 6 342. Each of the send work request's data segments contains a virtually contiguous memory space. The virtual addresses used to reference the local data segments are in the address context of the process that created the local queue pair.

In one embodiment, receive work queue 300 shown in FIG. 3 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero process-copy data transfer provides for efficient support of high-bandwidth and low-latency communication.

When a queue pair is created, the queue pair is set to provide a selected type of transport service. In one embodiment, a distributed computer system implementing the present invention supports four types of transport services: reliable connection, unreliable connection, reliable datagram, and unreliable datagram connection service.

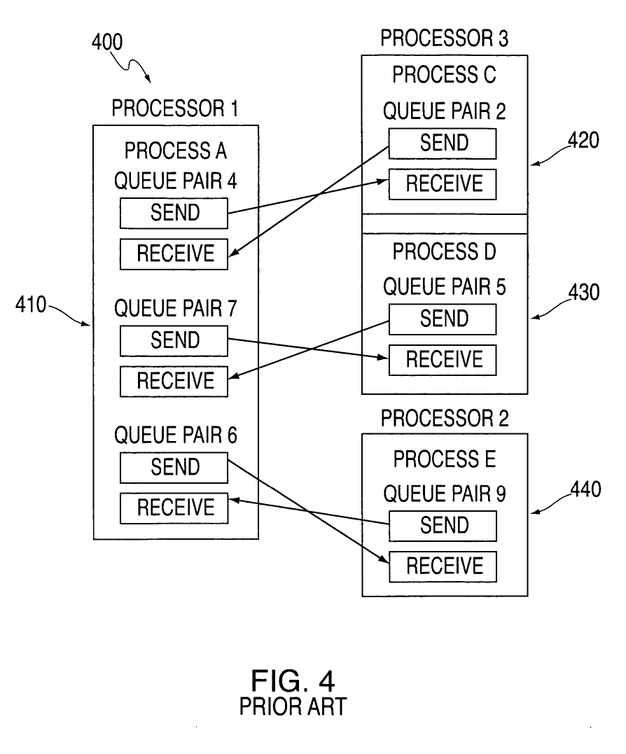

A portion of a distributed computer system employing a reliable connection service to communicate between distributed processes is illustrated generally in FIG. 4. The distributed computer system 400 in FIG. 4 includes a host processor node 1, a host processor node 2, and a host processor node 3. Host processor node 1 includes a process A 410. Host processor node 3 includes a process C 420 and a process D 430. Host processor node 2 includes a process E 440.

Host processor node 1 includes queue pairs 4, 6, and 7, each having a send work queue and receive work queue. Host processor node 2 has a queue pair 9 and host processor node 3 has queue pairs 2 and 5. The reliable connection service of distributed computer system 400 associates a local queue pair with one and only one remote queue pair. Thus, the queue pair 4 is used to communicate with queue pair 2; queue pair 7 is used to communicate with queue pair 5; and queue pair 6 is used to communicate with queue pair 9.

A WQE placed on one queue pair in a reliable connection service causes data to be written into the receive memory space referenced by a Receive WQE of the connected queue pair. RDMA operations operate on the address space of the connected queue pair.

In one embodiment, the reliable connection service is made reliable because hardware maintains sequence numbers and acknowledges all packet transfers. A combination of hardware and SAN driver software retries any failed communications. The process client of the queue pair obtains reliable communications even in the presence of bit errors, receive under runs, and network congestion. If alternative paths exist in the SAN fabric, reliable communications can be maintained even in the presence of failures of fabric switches, links, or channel adapter ports.

In addition, acknowledgements may be employed to deliver data reliably across the SAN fabric. The acknowledgment may, or may not, be a process level acknowledgment, i.e. an acknowledgment that validates that a receiving process has consumed the data. Alternatively, the acknowledgment may be one that only indicates that the data has reached its destination.

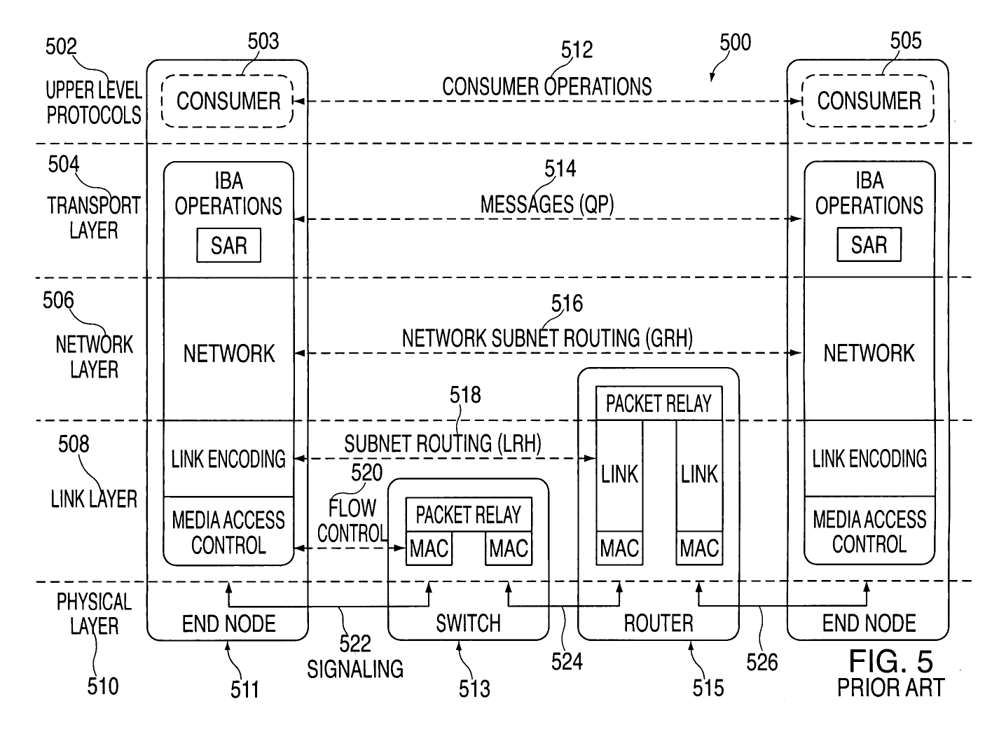

One embodiment of layered communication architecture 500 for implementing the present invention is generally illustrated in FIG. 5. The layered architecture diagram of FIG. 5 shows the various layers of data communication paths and organization of data and control information passed between layers.

Host channel adapter end node protocol layers (employed by end node 511, for instance) include upper level protocol 502 defined by consumer 503, a transport layer 504, a network layer 506, a link layer 508, and a physical layer 510. Switch layers (employed by switch 513, for instance) include link layer 508 and physical layer 510. Router layers (employed by router 515, for instance) include network layer 506, link layer 508, and physical layer 510.

Layered architecture 500 generally follows an outline of a classical communication stack. With respect to the protocol layers of end node 511, for example, upper layer protocol 502 employs verbs to create messages at transport layer 504. Network layer 506 routes packets between network subnets (516). Link layer 508 routes packets within a network subnet (518). Physical layer 510 sends bits or groups of bits to the physical layers of other devices. Each of the layers is unaware of how the upper or lower layers perform their functionality.

Consumers 503 and 505 represent applications or processes that employ the other layers for communicating between end nodes. Transport layer 504 provides end-to-end message movement. In one embodiment, the transport layer provides four types of transport services as described above which are reliable connection service; reliable datagram service; unreliable datagram service; and raw datagram service. Network layer 506 performs packet routing through a subnet or multiple subnets to destination end nodes. Link layer 508 performs flow-controlled, error checked, and prioritized packet delivery across links.

Physical layer 510 performs technology-dependent bit transmission. Bits or groups of bits are passed between physical layers via links 522, 524, and 526. Links can be implemented with printed circuit copper traces, copper cable, optical cable, or with other suitable links.

FIG. 6 shows timestamp recording and reporting for work requests and work completions according to an exemplary embodiment. FIG. 6 shows a main memory 600 separated from an adapter 602 by a dotted horizontal line.

Main memory 600 includes a send queue 604 and a completion queue 608. Send queue 604 holds a number of work queue elements (WQEs) (a/k/a work requests), such as WQEn 610 and has head 612 and tail 619 pointers. Completion queue 608 holds a number of completion queue elements (CQEs), such as CQEn 616 and also has head 618 and tail 620 pointers.

The adapter 602 is an I/O adapter, such as an InfiniBand™ HCA or an iWarp RNIC that uses the concepts of work requests and work completions. Work requests (WQEs) are posted to the send queue 604 and are used to pass information to the adapter 602. Work completions are retrieved from the completion queue 608 and are used to determine when a particular work request has completed.

In FIG. 6, Software (not shown) sets timestamp t1 (discussed below) when it posts WQEn to the send queue 604 and sets timestamp t4 (discussed below) when it retrieves CQEn from the completion queue 608. FIG. 6 also shows a CQE 622 that includes a work request identifier 624 and timestamps 626 and 628. The adapter 602 stores timestamp t3 628 when a work request completes in the completion queue element 622 along with stored value t2 626. The adapter 602 stores timestamp t2 in the QP context when the first packet is sent for WQEn 610.

In this exemplary embodiment, software that is executing in main memory 600 posts WQEs to the tail 619 of the send queue 604. The software may be, for example, an HCA driver (HCAD) or a driver or controlling software for the adapter 602. The hardware, adapter 602, processes each of the WQEs in order from the head 612 of the send queue 604. As it processes the WQE, it fetches the data that needs to be transmitted, and builds the packet that is to be transmitted. For reliable transports, the adapter waits for acknowledgements from the remote node, indicating that the data was received correctly. When the hardware processing of the WQE completes, the adapter 602, informs the software in main memory 600 of the completion by building a CQE and attaching the CQE to the tail 620 of the completion queue 608. Meanwhile, the software in main memory 600 is polling the completion queue 608 to see if WQEs have completed. The software reads CQEs off the head 618 of the completion queue 608. After reading a CQE, the software can retire that WQE associated with that CQE.

This exemplary embodiment includes a workload manager (not shown) that is a software program for monitoring transactions. For example, the workload manger might detect that one adapter is too busy and move work to a less busy adapter. Generally, the workload manager oversees whether transactions are completing in a timely manner. If not, then the workload manager performs analysis to determine the causes of the delays. Timing information helps the workload manager to diagnose problems, isolate where the problems are occurring, and generally ensure transactions complete in a timely manner.

The software generates and stores a timestamp t1 when it posts a particular WQE, WQEn 610, to the tail 619 of the send queue 604. When WQEn 610 completes, the software will retrieve the timestamp t1. In some operating environments, there might be a large number of send queues, like send queue 604, which are being processed by the hardware adapter 602. In addition, the hardware adapter 602 is working from the head 612 of the send queue 604, so the time taken for the hardware adapter 602 to process WQEn 610 that was just posted could be substantial.

After the hardware adapter 602 builds a packet for WQEn 610 to send out on the link, the hardware generates and stores a timestamp t2 when it is ready to send WQEn 610 on the link. Alternatively, in some embodiments, the hardware generates and stores a timestamp when it fetches WQEn 610. Timestamp t2 626 is stored in the QP context. In some embodiments, every WQE is timed and a timestamp t2 is stored for each one. Some embodiments support storing a predetermined number of timestamps in the QP context. Other embodiments support only storing one timestamp and have an indicator in the WQE to tell the hardware adapter 602 whether or not to time that particular WQE. Some embodiments also store timestamps in the WQEs.

The hardware adapter 602 may generate timestamps from its own local timer, while the software may generate timestamps from another timer that is local to the software. Therefore, hardware adapter 602—generated timestamps may need to be synchronized or correlated with software-generated timestamps. This synchronization can be achieved by the software periodically reading the adapter time and correlating it with its own local timer.

The hardware adapter 602 sends the packet for WQEn 610 on the link. Once that completes, e.g. acknowledgement from the remote node is received, the hardware adapter 602 builds CQEn 622, generates and stores timestamp t3 628 in CQE 622, places timestamp t2 626 in CQE 622, and stores CQEn 616 at the tail 620 of the completion queue 608.

Meanwhile, the software is polling the completion queue 608. In this example, there are several other CQEs ahead of CQEn 616 on the completion queue 608, namely CQEn-1, CQEn-2, CQEn-3, and CQEn-4. In some operating environments, there might be a large number of completion queues, like completion queue 608. Eventually, when CQEn is at the head 618 of the completion queue 608, the software generates and stores timestamp t4 and, then, processes CQEn 616. During processing, the software uses the work request ID 624 in CQEn 616 to associates it with a particular work request, WQEn 610, that was previously in the send queue 604.

At this point in the exemplary embodiment, there are four timestamps, two timestamps, t2 and t3, generated by the hardware adapter 602 and two timestamps, t1 and t4, generated by the software. Because the hardware adapter 602 and software may use different timers, there is a mechanism for correlating t2 and t3 with t1 and t4. For example, at 9:52.3271 seconds the software reads the hardware timer at 2,376 nanoseconds for correlation and synchronization. One simple approach is for the software, when it receives t2 and t3 in the CQEn 616, it converts them to software time. With this timestamp information, it is possible to determine how long it took to process WQEn 610.

Exemplary embodiments include mechanisms for providing timing information for the various stages of processing of the work requests so that the workload manager can identify sources of delay in transaction processing. Timestamps include quantifying the amount of time that an I/O request (1) spends on the send queue 604 before the adapters 602 start processing the work, (2) the time spent transmitting the message over the fabric, until it is successfully acknowledged, and (3) the time spent on the completion queue 608, before the software retrieves the work completion. This information is available on an I/O request-by-I/O request basis so that the I/O driver is able to associate these metrics with the proper workload.

This information, combined with other information acquired from the fabric (e.g., switches) and devices (e.g., control units) allow a system administrator or an autonomic workload manager to identify and correct resource imbalances. This information also allows resources to be managed with the knowledge of the relative importance of the delayed work.

An exemplary embodiment identifies the following four stages in the work request processing that are marked with a timestamp. Of course, various other kinds of timing information are within the scope of the present invention as well.

1. The time when the work request is posted to the send queue (t1).

2. The time when the first packet is sent on the link for that work request (t2).

3. The time when the work request has completed its processing and the adapter posts a work completion on the completion queue (t3).

4. The time when the work completion is retrieved by the software (t4).

Using the timestamps from these four stages, the workload manager can determine the following times. Of course, various other aspects and events may also be timed to help manage workload or otherwise improve efficiency and accountability within the scope of the present invention.

1. The time the adapter takes to start processing the work request after if has been posted, which includes the time to process other work requests on the same queue and on other queues (t2−t1);

2. The time taken to transmit the message over the fabric and be successfully acknowledged by the remote node (t3−t2); and

3. The time taken for software to retrieve the work completion from the completion queue, which includes the time to retrieve other work completions ahead of it on the completion queue (t4−t3).

The timestamps t1 and t4 are recorded by software as it posts work requests to the send queue and retrieves work completions from the completion queue, respectively. This is done using standard techniques for recording timestamps based on a processor clock.

The adapter hardware 602 records timestamps t2 and t3. The timestamp t2 is set when the first packet for a work request is sent on the link, to signify the end of the local adapters part of the processing of the work request. This value is stored in the QP context. It needs to be stored in the QP context until that work request completes at which time it is returned to the software in the completion queue element (CQE) on the completion queue (CQ).

In this exemplary embodiment, adapter 602 is a high performance adapter. In high performance adapters there may be more than one work request outstanding on a given QP, so the number of values of t2 that may be stored may be restricted. If the number is restricted, then the software needs to be aware of how many timestamps are capable of being stored and to signal to the adapter 602 when a work request needs to be timed. The software does not issue more of these timing requests to the adapter 602 than are supported, in this exemplary embodiment. Instead, the software issues new timing requests when a completion returns timing information for a previous timing request. These timing requests are passed in the WQE on the QP.

When a work request completes, such as when an acknowledgement is received for a reliable communication, the adapter 602 records the current timestamp (t3) and passes this along with the previously stored value t2 in the CQE 622 that is placed on the CQ 608. If there are multiple CQEs on the CQ, or if the interrupt processing time is long, it may take some time before the software retrieves this CQE. The difference between t4 and t3 is a measure of the length of time the CQE remains on the CQ before it is processed by the software.

The timestamps t2 and t3 are recorded based on an internal clock in the adapter 602. The adapter 602 provides a mechanism for software to read the current value of this clock. The software correlates the adapter clock with the software processor clock that is used for recording timestamps t1 and t4. This synchronization of timers is performed periodically so that each set of timestamp measurements t1 and t4 are correlated with t2 and t3 to determine a more accurate delay value.

Given a measure of network delay and responsiveness of the network adapter, an alternate path through the fabric may be used that is faster or less congested or another remote adapter may be used that is, perhaps on the same processing complex and less busy. Given a measure of how long it takes the software to process completions, the software may, for example, poll the completion queue 608 more frequently. Periodic snapshots of timing information help to manage any delays and allow work to be shifted to improve efficiency, as appropriate.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for timing work requests and completion processing, comprising:
storing, by a software driver, a time t1 when a work request is posted to a send queue;
posting, by a hardware adapter, a work completion corresponding to the work request to a completion queue, the work completion including a time t2 when the message for the work request is sent on the link and a time t3 when the work completion is posted to the completion queue;
retrieving, by the software driver, the work completion corresponding to the work request; and
storing, by the software driver, a time t4 when the work completion is retrieved from the completion queue.

2. The method of claim 1, further comprising:
determining a time taken by the hardware adapter to start processing the work request after the work request has been posted from time t1 and time t2.

3. The method of claim 1, further comprising:
determining a time taken to send the message from time t2 and time t3.

4. The method of claim 1, further comprising:
determining a time taken by the software driver to retrieve the work completion from the completion queue from time t4 and time t3.

5. The method of claim 1, wherein timing is only performed by the software driver and the hardware adapter when an indicator in the work request has a predetermined value.

6. The method of claim 1, further comprising:
managing workload by shifting work based on times t1, t2, t3, and t4.

7. The method of claim 1, wherein the time t2 when the message for the work request is sent on the link includes the time for receiving an acknowledgement from a remote node.

8. A system for timing work requests and completion processing, comprising:
a hardware adapter for sending packets on a link;
a software driver for controlling the hardware adapter;
a send queue for holding work requests; and
a completion queue for holding work completions;
wherein the software driver provides a time t1 when a work request is posted to the send queue, the hardware adapter provides a time t2 when a message for the work request is sent on the link, the hardware adapter provides a time t3 when a work completion corresponding to the work request is posted to the completion queue, and the software driver provides a time t4 when the work completion is retrieved from the completion queue.

9. The system of claim 8, wherein a time taken by the hardware adapter to start processing the work request after the work request has been posted is determined from time t1 and time t2.

10. The system of claim 8, wherein a time taken to send the message is determined from time t2 and time t3.

11. The system of claim 8, wherein a time taken by the software driver to retrieve the work completion from the completion queue is determined from time t4 and time t3.

12. The system of claim 8, wherein the software driver has a first timer and the hardware adapter has a second timer and the software driver correlates times from the second timer to times from the first timer.

13. The system of claim 8, wherein timing is only performed by the software driver and the hardware adapter when an indicator in the work request has a predetermined value.

14. The system of claim 8, further comprising:
a workload manager that shifts work based on times t1, t2, t3, and t4.

15. A storage medium for storing instructions for performing a method timing work requests and completion processing, the method comprising:
storing, by a software driver, a time t1 when a work request is posted to a send queue;
posting, by a hardware adapter, a work completion corresponding to the work request to a completion queue, the work completion including a time t2 when the message for the work request is sent on the link and a time t3 when the work completion is posted to the completion queue;
retrieving, by the software driver, the work completion corresponding to the work request; and
storing, by the software driver, a time t4 when the work completion is retrieved from the completion queue.
